(19) United States
(12) Patent Application Publication
(10) Pub. No.: US 2017/0185413 A1
(43) Pub. Date: Jun. 29, 2017

(54) Processing devices to perform a conjugate permute instruction

(71) Applicant: Intel Corporation, Santa Clara, CA (US)

(72) Inventors: Asit K. Mishra, Hillsboro, OR (US); Kshitij A. Doshi, Chandler, AZ (US); Elmoustapha Ould-Ahmed-Vall, Chandler, AZ (US); Jesus Corbal, Barcelona (ES); Deborah T. Marr, Portland, OR (US)

(21) Appl. No.: 14/998,151

(22) Filed: Dec. 23, 2015

(51) Int. Cl. G06F 9/38; G06F 15/80; G06F 9/30

(52) U.S. Cl. CPC G06F 9/3887; G06F 9/30036; G06F 9/30098; G06F 15/8007

(57) ABSTRACT

Single Instruction, Multiple Data (SIMD) technologies are described. A processer may include a first register to receive a plurality of source elements and second register. The processor may receive a permute index at a third register. The conjugate permute index has elements, each of which corresponds to one of the source elements. The processor then stores each of the source elements to a position in the second register based on a select element corresponding to the source element.

### BACKGROUND

Single Instruction, Multiple Data (SIMD) architectures can be implemented in microprocessor systems to enable one instruction to operate on several operands in parallel. SIMD architectures take advantage of packing multiple data elements within one register or contiguous memory location. With parallel hardware execution, multiple operations are performed on separate data elements by one instruction to increase a performance of the microprocessor systems.

### BRIEF DESCRIPTION OF THE DRAWINGS

Various embodiments of the present invention will be understood more fully from the detailed description given below and from the accompanying drawings of various embodiments of the invention.

FIG. 1 is a block diagram illustrating a computing system that implements a conjugate permute instruction according to one embodiment.

FIG. 2A illustrates a diagram of a method of performing a conjugate permute instruction according to one embodiment.

FIG. 2B illustrates a diagram of a method of performing conjugate permute instruction according to one embodiment.

FIG. 3A illustrates example operations of a Single Instruction, Multiple Data (SIMD) conjugate permute instruction according to one embodiment.

FIG. 3B illustrates example operations of a Single Instruction, Multiple Data (SIMD) conjugate permute instruction according to one embodiment.

FIG. 4 illustrates a block diagram of a hardware implementation of a conjugate permute instruction according to one embodiment.

FIG. 5A is a block diagram illustrating an in-order pipeline and a register renaming stage, out-of-order issue/execution pipeline according to one embodiment.

FIG. 5B is a block diagram illustrating a micro-architecture for a processor that implements secure memory repartitioning according to one embodiment.

FIG. 6 illustrates a block diagram of the micro-architecture for a processor that includes logic circuits to perform secure memory repartitioning according to one embodiment.

FIG. 7 is a block diagram of a computer system according to one implementation.

FIG. 8 is a block diagram of a computer system according to another implementation.

FIG. 9 is a block diagram of a system-on-a-chip according to one implementation.

FIG. 10 illustrates another implementation of a block diagram for a computing system according to one implementation.

FIG. 11 illustrates another implementation of a block diagram for a computing system according to one implementation.

### DESCRIPTION OF EMBODIMENTS

Some processors use vector instruction sets or single instruction, multiple data (SIMD) instruction sets to perform multiple operations in parallel. A processor can perform multiple operations in parallel, simultaneously applying operations to the same piece of data or multiple pieces of data at the same time. Vectorization is an operation to convert a scalar program that only operates on one pair of operands at once to a vector program that can run multiple operations from a single instruction. For example, vectorization is a process of rewriting a loop operation to perform a SIMD instruction, where instead of processing a single element of an array N times, it processes M elements of the array simultaneously N/M times.

Vectorization can include a permute instruction that causes the processor to store source elements from a source register to a destination register according to a permute control index. For example, an execution unit of a processor may gather elements from a source register to a destination register based on entries in a control index. A SIMD processor may, in parallel, store to each element of the destination register an element from the source register. For example, a permute index may have a set of values each corresponding to an element in the destination register. The values in the permute index may indicate an element in the source register to store to the corresponding element of the destination register. Thus, the processor may store a value to an element in the destination register based on the value of an element in the permute control index that corresponds to the element of the destination register. This may be described as a pull-based permute such that the processor pulls elements from the source register according to entries in permute index positions corresponding to elements of the destination register. For example, the entry at position x in the control index may point to an element y in the source register to store into position x of the destination register.

For certain applications it may be beneficial to have a conjugate permute instruction such that elements of the source register are pushed to the destination register according to the entry in an index associated with an element of the source register. For example, register sorting operations may be executed more efficiently using a conjugate permute instruction instead of a pull-based permute instruction. For instance, a processor may sort a register faster by comparing elements of a register and pushing them to a destination register than by pulling elements using additional operations. However, SIMD instruction sets may not include a conjugate permute instruction. Thus, to perform a conjugate permute to data packed in a source register, the data may be scattered in a memory cache and then gathered back into a register. However, these operations may adversely affect the performance at the processor. For example, scattering data to cache memory may cause the processor to write to memory caches having few write ports. For example, there may be only 1 write port available for some low level caches. Therefore, the performance of a push permute instruction adversely affect the performance of the processor by causing read and write instructions to memory locations instead of implementing the operation in processor registers.

The embodiments described herein address the above noted deficiencies by using a conjugate permute operation to eliminate the scatter and gather operations from cache memory in performance of the instruction. As described herein, the term conjugate permute describes pushing entries in a source register to a destination register based on a position indicated in a permute index. For example, each element in a permute index may correspond to an element in a source register. The processor may then store elements of the source register to elements of the destination register indicated by the permute index. In some embodiments, a conjugate permute instruction may be implemented in native hardware. For example, a SIMD processor may implement a conjugate in hardware by operatively coupling each element in the source register to a corresponding demultiplexer. Then the processor may couple each element in a conjugate permute index as a select element to a corresponding demultiplexer. Each element of the demultiplexer may then distribute the corresponding element of the source register to an element of the destination register indicated by the conjugate permute index. However, in some processor designs, adding native hardware implementation for a push based permute instruction may consume significant resources or space on an integrated circuit. Thus, a processor design may not include a native hardware implementation of the push based permute instruction. In some embodiments, a conjugate permute instruction may be implemented as a sequence of other instructions in a SIMD processor. For example, a set of instructions may be used to convert a conjugate permute index into a permute index. Then the processor may perform a permute operation using the permute index. This set of operations results in the same elements in the same order of the destination register as performing a conjugate permute instruction directly in native hardware.

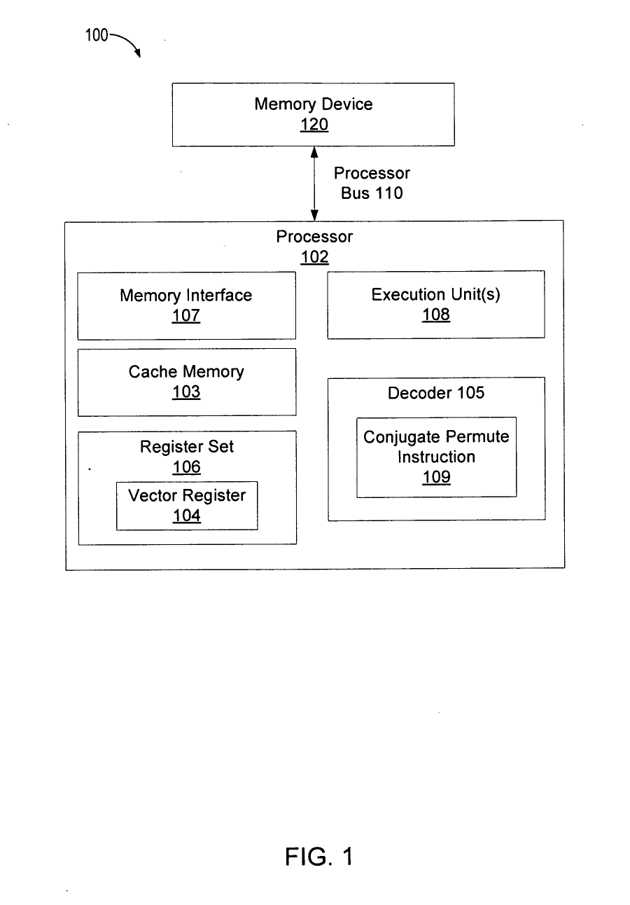

FIG. 1 is a block diagram illustrating a computing system 100 that implements a conjugate permute instruction according to one embodiment. The computing system 100 is formed with a processor 102 that includes one or more execution units 108 to execute a conjugate permute instruction 109 and a memory decoder 105 to decode a conjugate permute instruction 109. The conjugate permute instruction 109 implements one or more features in accordance with one or more embodiments as described herein. The computing system 100 may be any device, but the description of various embodiments described herein is directed to processors including one or more registers in a register set 106 and capable of performing one or more SIMD instructions.

A register set 103 includes one or more registers to store data elements used by execution unit(s) 108 during performance of instructions. The register set 106 may store different types of data in various registers including integer registers, floating point registers, vector registers, banked registers, shadow registers, checkpoint registers, status registers, and instruction pointer register. In particular, register set 106 may include a vector register 104 that holds data for vector processing by SIMD instructions. For example, vector register 104 may store source elements for use in performance of a conjugate permute instruction 109.

Decoder 105 may decode a conjugate permute instruction 109, which may specify a permute to perform on source elements in vector register 104. The execution unit 108 may then, in response to the decoded conjugate permute instruction 109, store source elements for the instruction into vector register 104. The execution unit 108 may then perform operations of the conjugate permute instruction 109. For example, the conjugate permute instruction may perform the methods described further below with reference to FIGS. 1B and 1C.

Execution unit 108, including logic to perform integer and floating point operations, as well as vector operations, also resides in the processor 102. It should be noted that the execution unit may or may not have a floating point unit. The processor 102, in one embodiment, includes a microcode read-only memory (ROM) to store microcode, which when executed, is to perform algorithms for certain macroinstructions or handle complex scenarios. For example; the microcode may include a set of operations to perform a conjugate permute instruction with an execution unit 108. In some embodiments, microcode may be potentially updateable to handle logic bugs/fixes for processor 102.

In some embodiments, an execution unit 108 may also be used in micro controllers, embedded processors, graphics devices, DSPs, and other types of logic circuits. In some embodiments, processor 102 includes a memory interface 107 and processor 102 is coupled to memory 120. In one embodiment, memory interface 107 may be a bus protocol for communication from processor 102 to memory 120. Memory 120 includes a dynamic random access memory (DRAM) device, a static random access memory (SRAM) device, flash memory device, or other memory device. Memory 120 stores instructions and/or data represented by data signals that are to be executed by the processor 102. For example, the memory 120 may include computer program instructions, which when compiled and decoded by decoder 105 instruct processor 102 to perform a conjugate permute instruction 109. The memory 120 may also include source elements for performing a conjugate permute instruction 109, an conjugate permute index, or may receive from the processor 102 results of a conjugate permute instruction 109.

The processor 102 is coupled to the memory 120 via a processor bus 110. A system logic chip, such as a memory controller hub (MCH) may be coupled to the processor bus 110 and memory 120. An MCH can provide a high bandwidth memory path to memory 120 for instruction and data storage and for storage of graphics commands, data and textures. The MCH can be used to direct data signals between the processor 102, memory 120, and other components in the system 100 and to bridge the data signals between processor bus 110, memory 120, and system I/O, for example. The MCH may be coupled to memory 120 through a memory interface (e.g., memory interface 107).

In some embodiments, the processor 102 may include an internal cache memory 104. Depending on the architecture, the processor 102 may have a single internal cache or multiple levels of internal caches. For example, the processor 102 may include a Level 1 (L1) internal cache memory and a Level 2 (L2) internal cache memory. In some embodiments, system 100 may include a combination of both internal and external caches depending on the particular implementation and needs. The execution unit 108 may access data from an internal cache memory 104 for implementing a conjugate permute instruction 109.

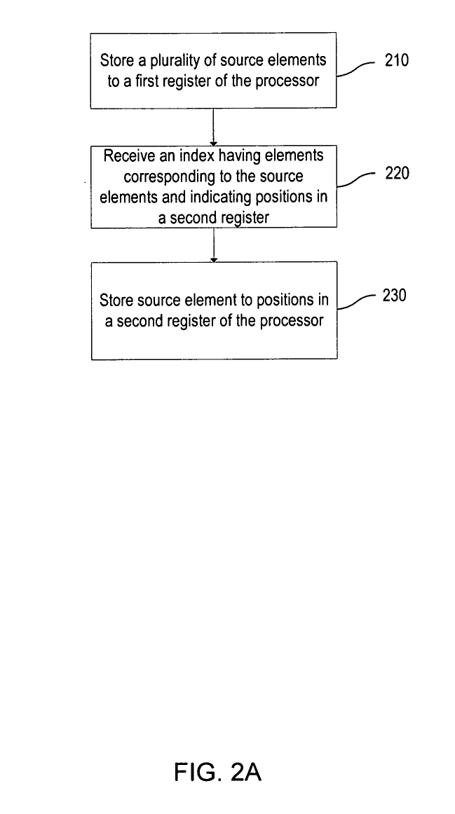

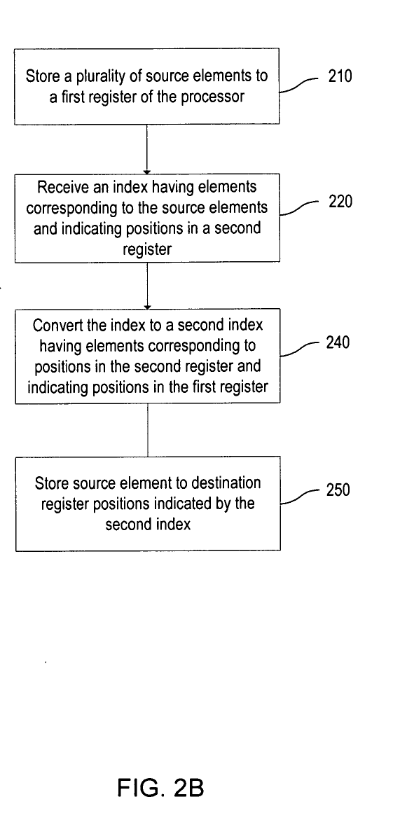

FIG. 2A illustrates a diagram of a method of performing a conjugate permute instruction on an array of values, according to one embodiment. The method may be at least partially performed by a processing device or processing logic that may include hardware (e.g. circuitry, dedicated logic, programmable logic, microcode, etc.), software (e.g., instructions executed by a processing device), firmware, or a combination thereof. For example, the method may be performed by the processor 102 described with reference to FIG. 1.

Referring to FIG. 2A, the method begins with storing a vector of source elements to a vector register in block 210. A vector register holds data for vector processing performed by SIMD instructions. For example, a vector register may contain elements for processing in parallel by an SIMD instruction. In some embodiments, another register type may be used for to store elements of source data. The source data may be any type of data for distribution to a destination register. For example a 16 byte register may contain 16 single byte elements for distribution to a destination register. In some other embodiments, different sized registers or data elements may be used. The source elements may be received from a memory device external to a processor executing the method, or from an internal cache memory location. The method continues in block 220 to store a conjugate permute index to a control register. Each entry in the conjugate permute index may correspond to an entry in the source vector having the same position in their respective vectors. For example, each element in the source register may be in a position having an offset from a base position of the source register. For example, a least significant byte of the source register may have an offset of zero, and each more significant byte may have an offset value of one value higher. An index vector may have a set of elements in positions corresponding to elements in the source vector. For example, each element of the index vector may be in a position of a corresponding source element of the source vector where corresponding elements have the same offset from respective base positions. The value of each element in the conjugate permute index may be an integer value indicating a destination register position to store the corresponding source vector entry. For example, each element of the index vector may have an integer value indicating a position of the second register for storing an element of the source register.

In block 230 the method continues to store source elements to destination register elements indicated by the conjugate permute index. A processor may store the source elements by performing a conjugate permute instruction by an execution unit. Each element in the source vector may be distributed to a destination register element identified by a corresponding select entry in the control vector. To explain further, the conjugate permute index may include, at each position i, a value of index[i]. A source register may include, at each position i, a value source[i]. A destination register may include, at each position j, a value destination[j]. Thus, for a conjugate permute instruction, a processor may copy a value stored at the i-th position of the source register to the j-th position of the destination register, such that j=index[i].

FIG. 2B illustrates a diagram of another method of performing a conjugate permute operation on a set of source data according to one embodiment. In the method of FIG. 2B, a processor implements operations of a conjugate permute instruction by converting the conjugate permute index to a permute index and then performing a permute instruction. The method may be at least partially performed by a processing device or processing logic that may include hardware (e.g. circuitry, dedicated logic, programmable logic, microcode, etc.), software (e.g., instructions executed by a processing device), firmware, or a combination thereof.

Referring to FIG. 2B, the method may perform the processes of blocks 210 and 220 in the same manner as described above with references to FIG. 2A. For example, the processor may receive a set of source data elements to a source register and receive an index with an instruction to perform a conjugate permute instruction. The conjugate permute index may include a plurality of elements corresponding to source elements having the same offset in their respective vectors.

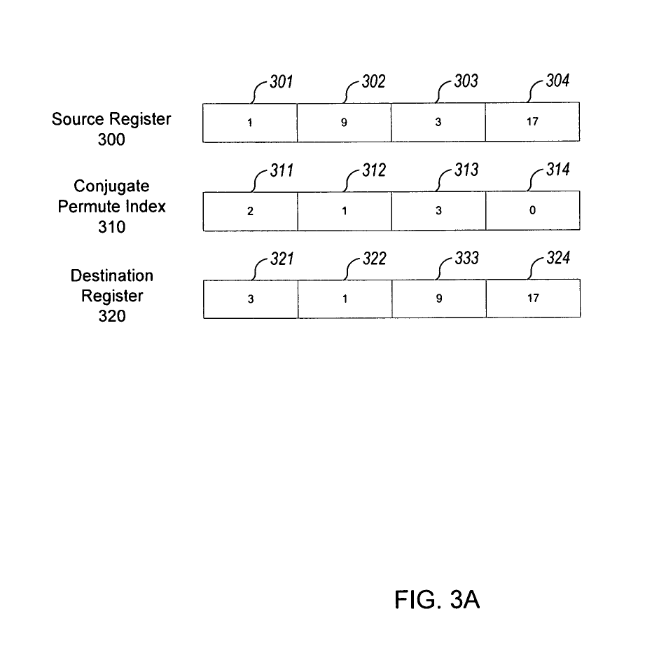

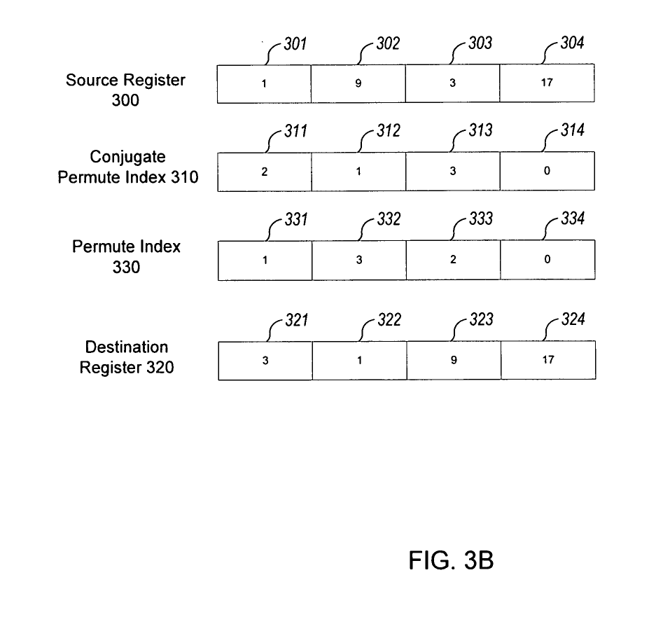

In some embodiments, the method may include converting the index to a second index having elements corresponding to positions in the second register and indicating positions in the first register in block 240. For example, a processor may convert a conjugate permute index for use with a conjugate permute instruction to a permute index for use with a permute instruction. To convert the conjugate permute index to a permute index, for each element in the conjugate permute index, the method may generate an entry in a permute index. For example, for an entry in the conjugate permute index with a value x at position i, the process may generate an entry at position x of the permute index with a value of i. Thus, each entry in the conjugate permute index may have a value of index[i] at position i of the index. Each entry in the permute index may have a value of index2[j] at position j of the index. Converting the conjugate permute index to a permute index may include generating a permute index with a value of i at position index[i] of the permute index such that for each position i in the conjugate permute index, there is an entry for index2[index[i]] equal to i. An example of converting a conjugate permute index to a permute index is described further with reference to FIG. 3B.

Continuing to block 250, the method stores source elements to destination register lanes indicated by the second index. For example, a SIMD processor may perform a pull based permute instruction on elements of the source vector according to the permute index generated in block 240 of the method in FIG. 2B. Each element in the second index may be at a position having an offset from a base position of the second index corresponding to a position in the second register. Each element of the second index may have an integer value identifying a source element to store at the corresponding position in the destination register. The processor may store the elements to a destination register by gathering from the position in the source vector indicated by the generated pull permute index. For example, the converted permute index may include, at each position i, a value index2[i]. A source register may include, at each position j, a value source[j]. A destination register may include, at each position k, a value destination[k]. Thus, for a pull based permute instruction, a processor may store, to each position in the destination register, a value destination[i] equal to source[index2[i]].

FIG. 3A illustrates an example of registers of a processor during performance of a SIMD conjugate permute instruction, according to an embodiment. The SIMD instruction is an example of an implementation of the method described in FIG. 2A. In the example of FIG. 3A, the SIMD instruction operates on a memory register with 4 elements. In other implementations, the SIMD register may include 8 elements, 16 elements, or another number of elements. The SIMD instruction may include a conjugate permute instruction to push entries in a source register to a destination register based on values in a conjugate permute index.

Source register 300 may include an array of elements 301-304 that store source data elements for distribution by the conjugate permute instruction. For consistency the registers illustrated in FIGS. 3A an 3B are shown with the most significant data element on the left and the least significant data element on the right. For example, the value in element 304 represents location 0 in the register, the value in element 303 represents location 1 in the register, the value in element 302 represents location 2 in the register, and the value in element 301 represents location 3 in the register. A processor may receive the data in the source register, a conjugate permute index, and an instruction to perform a conjugate permute instruction from software operating on the processor.

Row 310 is an array of select elements 311-314 that store input values of a conjugate permute index. For example, each value in the conjugate permute index 310 may have a corresponding element in source register 300 that has the same position in the register. The elements in permute index 310 may indicate a position in destination register 320 for storing the value from the corresponding element in the source register. For example, a value in element 301 may be distributed according to a value in select element 311 of the conjugate permute index, a value in element 302 may be distributed according to a value in select element 312 of the conjugate permute index, a value in element 303 may be distributed according to a value in select element 313 of the conjugate permute index, and a value in element 304 may be distributed according to a value in select element 314 of the conjugate permute index.

In the example of FIG. 3A, the value in the most significant position of the source register is ‘1’. The corresponding value in the most significant position of the conjugate permute index is ‘2’. The processor distributes the value in the most significant position of the source register to the position in the destination register indicated by the corresponding value in the permute index. For example, the value ‘1’ in the most significant position of the source register 300 is stored in the second position of the destination register 320 according to the entry ‘2’ in the most significant position of conjugate permute index 310. The value ‘9’ in the second position of the source register 300 is stored into the first position of the destination register 320 according to the entry ‘1’ in the second position of the permute index 310. The value ‘3’ in the first position of the source register 300 is stored into the third position of the destination register 320 according to the entry ‘3’ in the first position of the permute index 310. The value ‘17’ in the zeroth position of the source register 300 is stored into the zeroth position of the destination register 320 according to the entry ‘0’ in the zeroth position of the permute index 310. The result in the destination register represents the end of the permute instruction and may be used by the processor, by software running on the processor, or may be stored to a memory location.

FIG. 3B illustrates an example of registers of a processor during performance of a SIMD conjugate permute instruction, according to an embodiment. The conjugate permute instruction is an example of an implementation of the method described in FIG. 1B. In the example of FIG. 3B, the SIMD instruction operates on a memory register with 4 elements. In other implementations, the SIMD register may include 8 elements, 16 elements, or another number of elements. The SIMD instruction may include a permute instruction to pull entries from a source register to a destination register based on values in a permute index. The permute index may be generated by converting a conjugate permute index to a permute index.

Source register 300 may include an array of elements 301-304 that store source data elements for distribution by the conjugate permute instruction. Row 310 is an array of select elements 311-314 that store input values of a conjugate permute index. Each value in the conjugate permute index 310 may have a corresponding element in source register 300 that has the same position in the register. For example, similar to FIG. 3A, each value in the conjugate permute index 310 may indicate a position in destination register 320 for storing the corresponding element in the source register. In the example of FIG. 3B, the value in the most significant position of the source register is ‘1’. The corresponding value in the most significant position of the permute index is ‘2’. The processor distributes the value in the most significant position of the source register to the position in the destination register indicated by the corresponding value in the conjugate permute index. In some embodiments, a processor may not have native hardware implementation of a conjugate permute instruction. In such embodiments, a processor may convert the conjugate permute index to a permute index and perform operations of a permute instruction using the permute index. For example, each entry in conjugate permute index 310 may be converted to an entry in a permute index for use by the processor.

In the example of FIG. 3B, the value ‘1’ in the most significant position of the source register 300 is to be stored in the second position of the destination register 320 according to the entry ‘2’ in the most significant position of conjugate permute index 310. However, in order to perform the operation of a conjugate permute instruction using a permute instruction, the entry is converted to an entry in a permute index. In the example, the value ‘2’ in select element 311 indicates that the most significant position of the source register is to be stored into the second position of the destination register. Thus, for a permute instruction to achieve the same result, the second position of the permute index should indicate to the processor to gather the value from the third position of the source register. Therefore, the second position of the permute index has the value ‘3’ as element 332. Similarly, the entry ‘1’ in the second position of the conjugate permute index generates and entry of ‘2’ in the first position of the permute index, the entry of ‘3’ in the first position of the conjugate permute index generates and entry of ‘1’ in the third position of the permute index, and the entry of ‘0’ in the zeroth position of the conjugate permute index generates an entry of ‘0’ in the zeroth position of the permute index.

The processor may then perform the operations of a permute instruction on each element of the source register 300 according to the permute index 330. For example, the processor may copy the value from the first position of the source register to the third position of the destination register based on the entry ‘1’ in element 331 of the permute index 330. The processor may copy the value from the third position of the source register to the second position of the destination register based on the entry ‘3’ in element 332 of the permute index. The processor may copy the value from the second position of the source register to the first position of the destination register based on the entry ‘2’ in element 333 of the permute index. Finally, the processor may copy the value from the zeroth position of the source register to the zeroth position of the destination register based on the entry ‘0’ in element 334 of the permute index.

Similar to the result in FIG. 3A, after converting the conjugate permute index to a permute index and performing a permute instruction, the result in the destination register is the same. For example, the value ‘9’ in the second position of the source register 300 is stored into the first position of the destination register 320 according to the entry ‘1’ in the second position of the conjugate permute index 310. The value ‘3’ in the first position of the source register 300 is stored into the third position of the destination register 320 according to the entry ‘3’ in the first position of the conjugate permute index 310. The value ‘17’ in the zeroth position of the source register 300 is stored into the zeroth position of the destination register 320 according to the entry ‘0’ in the zeroth position of the conjugate permute index 310.

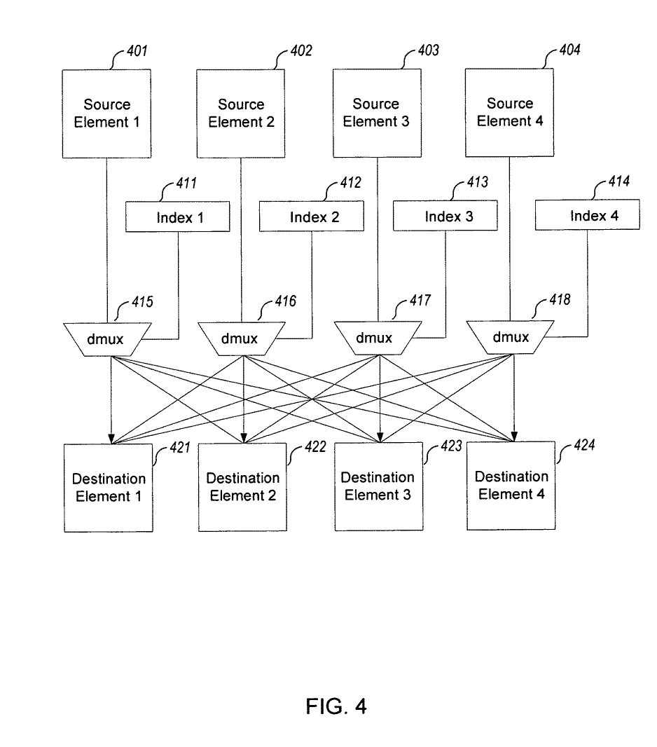

FIG. 4 is a block diagram illustrating a hardware implementation of a conjugate permute instruction. In the example of FIG. 4, the SIMD instruction operates on a memory register with 4 memory locations. In other implementations, the SIMD register may include 8 memory locations, 16 memory locations, or another number of memory locations. FIG. 4 illustrates one example of a hardware implementation of a conjugate permute instruction. Other embodiments may include different hardware or different hardware configurations to perform a conjugate permute instruction.

In FIG. 4, source elements 401-404 may represent particular locations in a source register. For example, the source locations 401-404 may be the same as cells 301-304 described with reference to FIG. 3A. A processor having source elements 401-404 may implement a conjugate permute instruction that stores each element 401-404 in the source register to a destination register element 421-424 according to a conjugate permute index 411-414. Each source element may be coupled to a corresponding demultiplexer (dmux) 415-418 to determine an output to a destination register. For example, source element 401 is coupled to corresponding demultiplexer 415.

Index select elements 411-414 may represent particular cells in a control register. The elements in the control register indicate to a processor where in a destination register to store elements of the source register. Index select elements 411-414 may represent particular elements 311-314 in the permute index 310 shown in FIG. 3A, for example. As shown in FIG. 4, each element of the index is provided to a corresponding demultiplexer to determine a destination element for each source element. For example, select element 411 may be coupled to a select input of demultiplexer 415 to determine a destination register position for source element 401.

Each demultiplexer 415-418 may be coupled to each lane in a destination register 421-424. For example, demultiplexer 415 has an output coupled to destination element 421, an output coupled to destination element 422, an output coupled to destination element 423, and an output coupled to destination element 424. Depending on the value received at a select input from a corresponding index, each demultiplexer provides its corresponding source element to a particular destination element. Thus, each demultiplexer receives a source data element as an input value, and a permute index value as a select input. The demultiplexer then provides the source data element to a particular destination register lane indicated by the select input. The processor may couple the demultiplexers to the source register and destination register in response to receiving an instruction to perform the conjugate permute instruction.

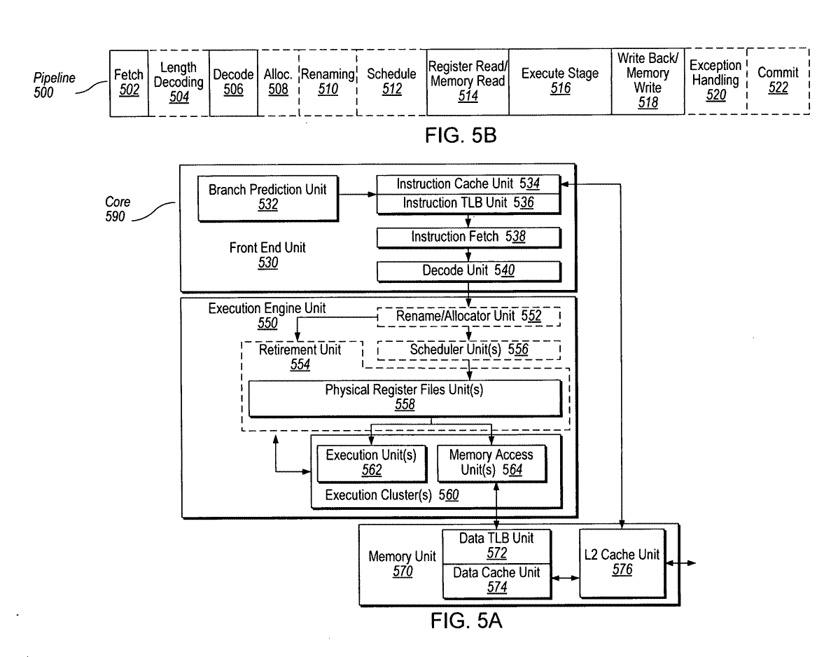

FIG. 5A is a block diagram illustrating a micro-architecture for a processor core 590 that implements a conjugate permute instruction according to one embodiment. Specifically, processor core (also simply ‘processor’) 590 depicts an in-order architecture core and a register renaming logic, out-of-order issue/execution logic to be included in a processor according to at least one embodiment of the disclosure. The embodiments of the page additions and content copying can be implemented in processor 500.

Processor 590 includes a front end unit 530 coupled to an execution engine unit 550, and both are coupled to a memory unit 570. The processor 590 may include a reduced instruction set computing (RISC) core, a complex instruction set computing (CISC) core, a very long instruction word (VLIW) core, or a hybrid or alternative core type. As yet another option, processor 590 may include a special-purpose core, such as, for example, a network or communication core, compression engine, graphics core, or the like. In one embodiment, processor 590 may be a multi-core processor or may be part of a multi-processor system.

The front end unit 530 includes a branch prediction unit 532 coupled to an instruction cache unit 534, which is coupled to an instruction translation lookaside buffer (TLB) 536, which is coupled to an instruction fetch unit 538, which is coupled to a decode unit 540. The decode unit 540 (also known as a decoder) may decode instructions, and generate as an output one or more micro-operations, micro-code entry points, microinstructions, other instructions, or other control signals, which are decoded from, or which otherwise reflect, or are derived from, the original instructions. The decoder 540 may be implemented using various different mechanisms. Examples of suitable mechanisms include, but are not limited to, look-up tables, hardware implementations, programmable logic arrays (PLAs), microcode read only memories (ROMs), etc. The instruction cache unit 534 is further coupled to the memory unit 570. The decode unit 540 is coupled to a rename/allocator unit 552 in the execution engine unit 550.

The execution engine unit 550 includes the rename/allocator unit 552 coupled to a retirement unit 554 and a set of one or more scheduler unit(s) 556. The scheduler unit(s) 556 represents any number of different schedulers, including reservations stations (RS), central instruction window, etc. The scheduler unit(s) 556 is coupled to the physical register file(s) unit(s) 558. Each of the physical register file(s) units 558 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 558 is overlapped by the retirement unit 554 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.).

Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 554 and the physical register file(s) unit(s) 558 are coupled to the execution cluster(s) 560. The execution cluster(s) 560 includes a set of one or more execution units 562 and a set of one or more memory access units 564. The execution units 562 may perform various operations (e.g., shifts, addition, subtraction, multiplication) and operate on various types of data (e.g., scalar floating point, packed integer, packed floating point, vector integer, vector floating point).

While some embodiments may include a number of execution units dedicated to specific functions or sets of functions, other embodiments may include only one execution unit or multiple execution units that all perform all functions. The scheduler unit(s) 556, physical register file(s) unit(s) 558, and execution cluster(s) 560 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 564). It should also be understood that where separate pipelines are used, one or more of these pipelines may be out-of-order issue/execution and the rest in-order.

The set of memory access units 564 is coupled to the memory unit 570, which may include a data prefetcher 580, a data TLB unit 572, a data cache unit (DCU) 574, and a level 2 (L2) cache unit 576, to name a few examples. In some embodiments DCU 574 is also known as a first level data cache (L1 cache). The DCU 574 may handle multiple outstanding cache misses and continue to service incoming stores and loads. It also supports maintaining cache coherency. The data TLB unit 572 is a cache used to improve virtual address translation speed by mapping virtual and physical address spaces. In one exemplary embodiment, the memory access units 564 may include a load unit, a store address unit, and a store data unit, each of which is coupled to the data TLB unit 572 in the memory unit 570. The L2 cache unit 576 may be coupled to one or more other levels of cache and eventually to a main memory.

In one embodiment, the data prefetcher 580 speculatively loads/prefetches data to the DCU 574 by automatically predicting which data a program is about to consume. Prefetching may refer to transferring data stored in one memory location (e.g., position) of a memory hierarchy (e.g., lower level caches or memory) to a higher-level memory location that is closer (e.g., yields lower access latency) to the processor before the data is actually demanded by the processor. More specifically, prefetching may refer to the early retrieval of data from one of the lower level caches/memory to a data cache and/or prefetch buffer before the processor issues a demand for the specific data being returned.

The processor 590 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.). The processor 590 may support a conjugate permute instruction for distributing elements in a source register to particular destination register lanes based on a permute index.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes a separate instruction and data cache units and a shared L2 cache unit, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

FIG. 5B is a block diagram illustrating an in-order pipeline and a register renaming stage, out-of-order isfsue/execution pipeline implemented by processor 590 of FIG. 5A according to some embodiments of the disclosure. The solid lined boxes in FIG. 5B illustrate an in-order pipeline, while the dashed lined boxes illustrates a register renaming, out-of-order issue/execution pipeline. In FIG. 5B, a processor pipeline 500 includes a fetch stage 502, a length decode stage 504, a decode stage 506, an allocation stage 508, a renaming stage 510, a scheduling (also known as a dispatch or issue) stage 512, a register read/memory read stage 514, an execute stage 516, a write back/memory write stage 518, an exception handling stage 522, and a commit stage 524. In some embodiments, the ordering of stages 502-524 may be different than illustrated and are not limited to the specific ordering shown in FIG. 5B.

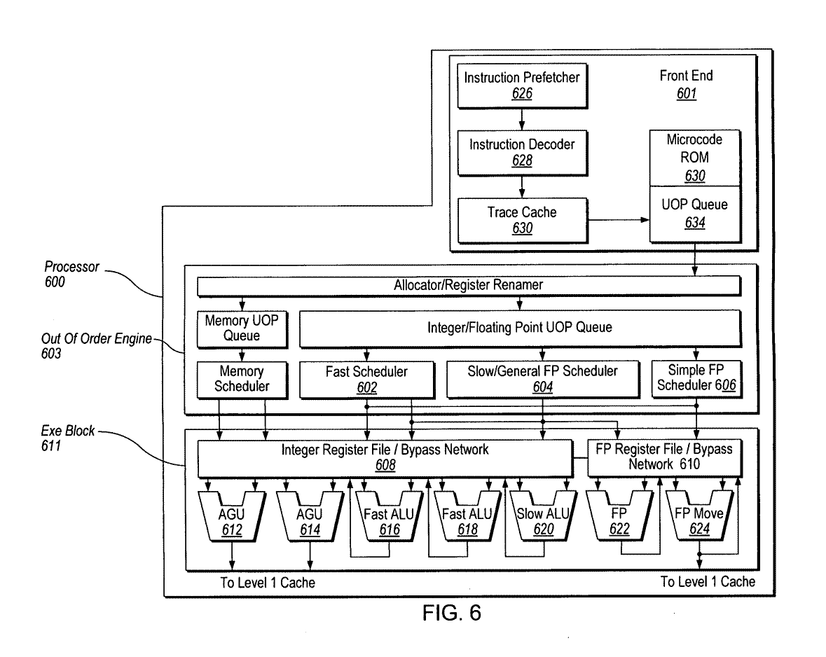

FIG. 6 illustrates a block diagram of the micro-architecture for a processor 600 that includes logic circuits to perform a conjugate permute instruction according to one embodiment. In some embodiments, an instruction in accordance with one embodiment can be implemented to operate on data elements having sizes of byte, word, doubleword, quadword, etc., as well as datatypes, such as single and double precision integer and floating point datatypes. In one embodiment the in-order front end 601 is the part of the processor 600 that fetches instructions to be executed and prepares them to be used later in the processor pipeline. The embodiments of the page additions and content copying can be implemented in processor 600.

The front end 601 may include several units. In one embodiment, the instruction prefetcher 616 fetches instructions from memory and feeds them to an instruction decoder 618 which in turn decodes or interprets them. For example, in one embodiment, the decoder decodes a received instruction into one or more operations called “micro-instructions” or “micro-operations” (also called micro op or uops) that the machine can execute. In other embodiments, the decoder parses the instruction into an opcode and corresponding data and control fields that are used by the micro-architecture to perform operations in accordance with one embodiment. In one embodiment, the trace cache 630 takes decoded uops and assembles them into program ordered sequences or traces in the uop queue 634 for execution. When the trace cache 630 encounters a complex instruction, the microcode ROM 632 provides the uops needed to complete the operation.

Some instructions are converted into a single micro-op, whereas others need several micro-ops to complete the full operation. In one embodiment, if more than four micro-ops are needed to complete an instruction, the decoder 618 accesses the microcode ROM 632 to do the instruction. For one embodiment, an instruction can be decoded into a small number of micro-ops for processing at the instruction decoder 618. In another embodiment, an instruction can be stored within the microcode ROM 632 should a number of micro-ops be needed to accomplish the operation. The trace cache 630 refers to an entry point programmable logic array (PLA) to determine a correct micro-instruction pointer for reading the micro-code sequences to complete one or more instructions in accordance with one embodiment from the micro-code ROM 632. After the microcode ROM 632 finishes sequencing micro-ops for an instruction, the front end 601 of the machine resumes fetching micro-ops from the trace cache 630.

The out-of-order execution engine 603 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 602, slow/general floating point scheduler 604, and simple floating point scheduler 606. The uop schedulers 602, 604, 606, determine when a uop is ready to execute based on the readiness of their dependent input register operand sources and the availability of the execution resources the uops need to complete their operation. The fast scheduler 602 of one embodiment can schedule on each half of the main clock cycle while the other schedulers can only schedule once per main processor clock cycle. The schedulers arbitrate for the dispatch ports to schedule uops for execution.

Register files 608, 610, sit between the schedulers 602, 604, 606, and the execution units 612, 614, 616, 618, 620, 622, 624 in the execution block 611. There is a separate register file 608, 610, for integer and floating point operations, respectively. Each register file 608, 610, of one embodiment also includes a bypass network that can bypass or forward just completed results that have not yet been written into the register file to new dependent uops. The integer register file 608 and the floating point register file 610 are also capable of communicating data with the other. For one embodiment, the integer register file 608 is split into two separate register files, one register file for the low order 32 bits of data and a second register file for the high order 32 bits of data. The floating point register file 410 of one embodiment has 128 bit wide entries because floating point instructions typically have operands from 64 to 128 bits in width.

The execution block 611 contains the execution units 612, 614, 616, 618, 620, 622, 624, where the instructions are actually executed. This section includes the register files 608, 610, that store the integer and floating point data operand values that the micro-instructions need to execute. The processor 600 of one embodiment is comprised of a number of execution units: address generation unit (AGU) 612, AGU 614, fast ALU 616, fast ALU 618, slow ALU 620, floating point ALU 622, floating point move unit 624. For one embodiment, the floating point execution blocks 612, 614, execute floating point, MMX, SIMD, and SSE, or other operations. The floating point ALU 612 of one embodiment includes a 64 bit by 64 bit floating point divider to execute divide, square root, and remainder micro-ops. For embodiments of the present disclosure, instructions involving a floating point value may be handled with the floating point hardware.

In one embodiment, the ALU operations go to the high-speed ALU execution units 616, 618. The fast ALUs 616, 618, of one embodiment can execute fast operations with an effective latency of half a clock cycle. For one embodiment, most complex integer operations go to the slow ALU 610 as the slow ALU 610 includes integer execution hardware for long latency type of operations, such as a multiplier, shifts, flag logic, and branch processing. Memory load/store operations are executed by the AGUs 612, 614. For one embodiment, the integer ALUs 616, 618, 620, are described in the context of performing integer operations on 64 bit data operands. In alternative embodiments, the ALUs 616, 618, 620, can be implemented to support a variety of data bits including 16, 32, 128, 256, etc. Similarly, the floating point units 612, 614, can be implemented to support a range of operands having bits of various widths. For one embodiment, the floating point units 612, 614, can operate on 128 bits wide packed data operands in conjunction with SIMD and multimedia instructions.

In one embodiment, the uops schedulers 602, 604, 606, dispatch dependent operations before the parent load has finished executing. As uops are speculatively scheduled and executed in processor 600, the processor 600 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one embodiment of a processor are also designed to catch instruction sequences for text string comparison operations.

The processor 600 also includes logic to implement a conjugate permute instruction according to one embodiment. In one embodiment, the execution block 611 of processor 600 may include a microcontroller (MCU), to perform a conjugate permute instruction according to the description herein.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight or sixteen multimedia SIMD registers for packed data.

For the discussions herein, the registers are understood to be data registers designed to hold packed data, such as 64 bits wide MMX™ registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

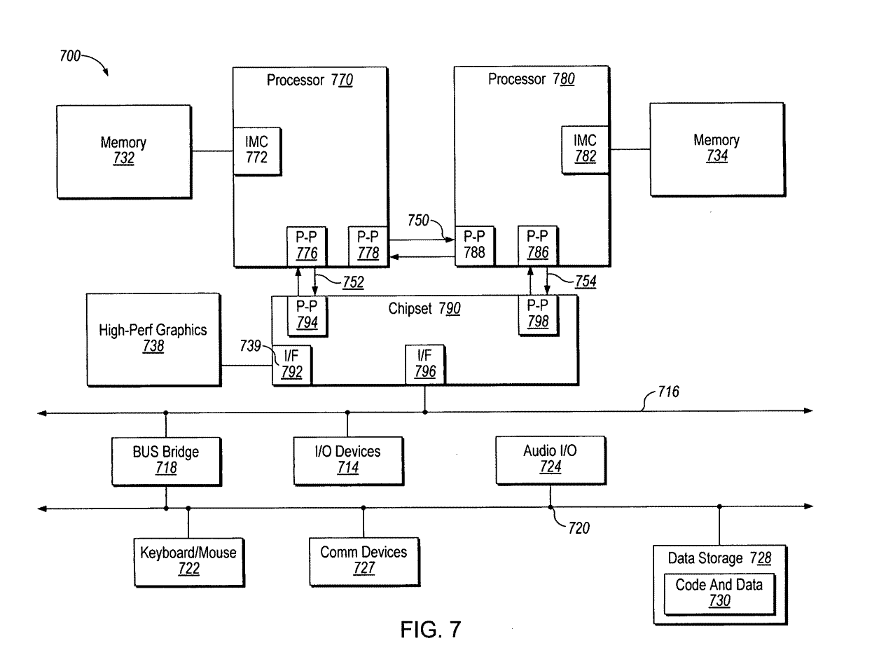

Embodiments may be implemented in many different system types. Referring now to FIG. 7, shown is a block diagram of a multiprocessor system 700 in accordance with an implementation. As shown in FIG. 7, multiprocessor system 700 is a point-to-point interconnect system, and includes a first processor 770 and a second processor 780 coupled via a point-to-point interconnect 750. As shown in FIG. 7, each of processors 770 and 780 may be multicore processors, including first and second processor cores, although potentially many more cores may be present in the processors. The processors each may include hybrid write mode logics in accordance with an embodiment of the present. The embodiments of the page additions and content copying can be implemented in the processor 770, processor 780, or both.

While shown with two processors 770, 780, it is to be understood that the scope of the present disclosure is not so limited. In other implementations, one or more additional processors may be present in a given processor.

Processors 770 and 780 are shown including integrated memory controller units (IMCs) 772 and 782, respectively. Processor 770 also includes as part of its bus controller units point-to-point (P-P) interfaces 776 and 788; similarly, second processor 780 includes P-P interfaces 786 and 788. Processors 770, 780 may exchange information via a point-to-point (P-P) interface 750 using P-P interface circuits 778, 788. As shown in FIG. 7, IMCs 772 and 782 couple the processors to respective memories, namely a memory 732 and a memory 734, which may be portions of main memory locally attached to the respective processors.

Processors 770, 780 may each exchange information with a chipset 790 via individual P-P interfaces 752, 754 using point to point interface circuits 776, 794, 786, 798. Chipset 790 may also exchange information with a high-performance graphics circuit 738 via a high-performance graphics interface 739.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the present disclosure is not so limited.

As shown in FIG. 7, various I/O devices 714 may be coupled to first bus 716, along with a bus bridge 718 which couples first bus 716 to a second bus 720. In one embodiment, second bus 720 may be a low pin count (LPC) bus. Various devices may be coupled to second bus 720 including, for example, a keyboard and/or mouse 722, communication devices 727 and a storage unit 728 such as a disk drive or other mass storage device which may include instructions/code and data 730, in one embodiment. Further, an audio I/O 724 may be coupled to second bus 720. Note that other architectures are possible. For example, instead of the point-to-point architecture of FIG. 7, a system may implement a multi-drop bus or other such architecture.

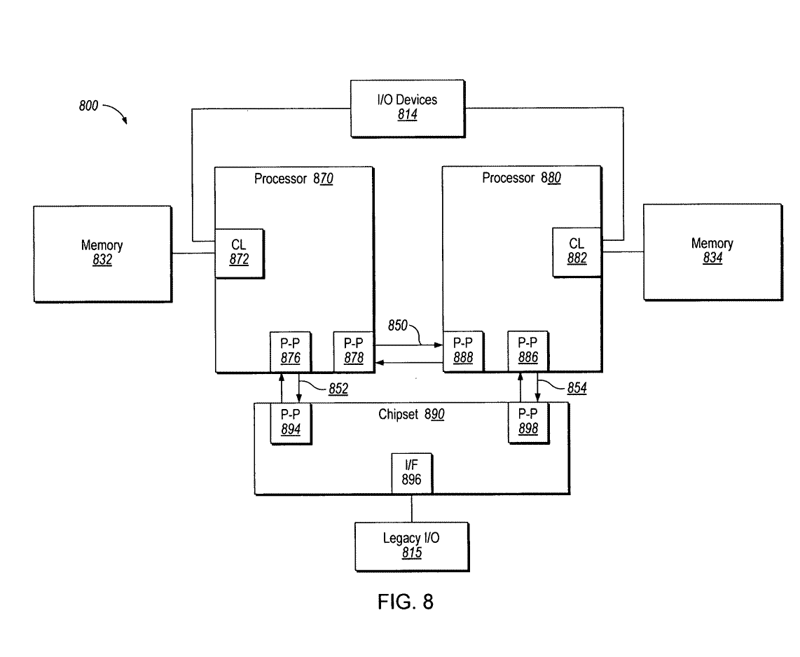

Referring now to FIG. 8, shown is a block diagram of a third system 800 in accordance with an embodiment of the present invention. Like elements in FIGS. 7 and 8 bear like reference numerals, and certain aspects of FIG. 7 have been omitted from FIG. 8 in order to avoid obscuring other aspects of FIG. 8.

FIG. 8 illustrates that the processors 870, 880 may include integrated memory and I/O control logic (“CL”) 872 and 882, respectively. For at least one embodiment, the CL 872, 882 may include integrated memory controller units such as described herein. In addition. CL 872, 882 may also include I/O control logic. FIG. 7 illustrates that the memories 832, 834 are coupled to the CL 872, 882, and that I/O devices 814 are also coupled to the control logic 872, 882. Legacy I/O devices 815 are coupled to the chipset 890. The embodiments of the page additions and content copying can be implemented in processor 870, processor 880, or both.

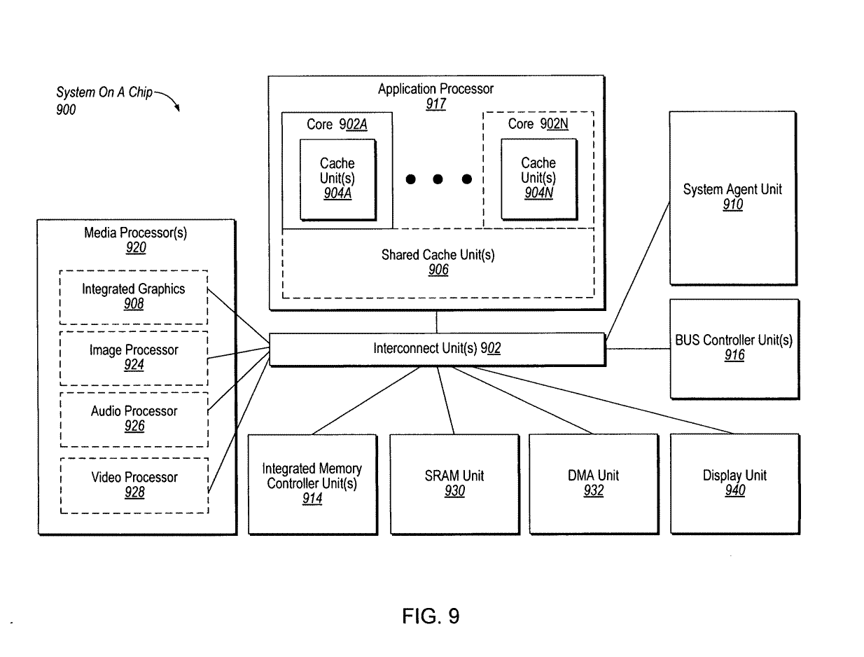

FIG. 9 is an exemplary system on a chip (SoC) 900 that may include one or more of the cores 902. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

FIG. 9 is a block diagram of a SoC 900 in accordance with an embodiment of the present disclosure. Dashed lined boxes are features on more advanced SoCs. In FIG. 9 an interconnect unit(s) 902 is coupled to: an application processor 917 which includes a set of one or more cores 902A-N and shared cache unit(s) 906; a system agent unit 910; a bus controller unit(s) 916; an integrated memory controller unit(s) 914; a set or one or more media processors 920 which may include integrated graphics logic 908, an image processor 924 for providing still and/or video camera functionality, an audio processor 926 for providing hardware audio acceleration, and a video processor 928 for providing video encode/decode acceleration; a static random access memory (SRAM) unit 930; a direct memory access (DMA) unit 932; and a display unit 940 for coupling to one or more external displays. The embodiments of the pages additions and content copying can be implemented in SoC 900.

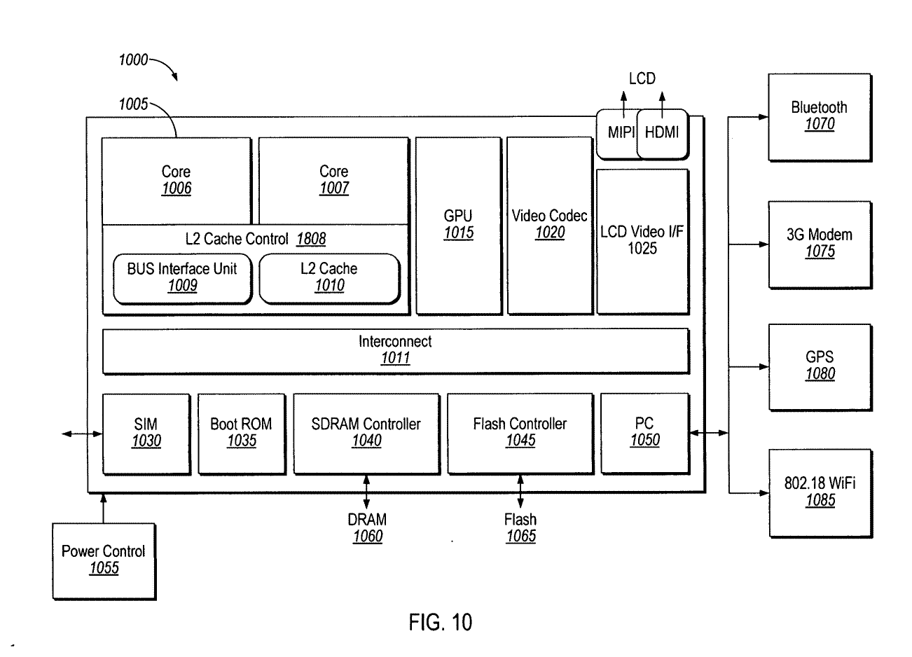

Turning next to FIG. 10, an embodiment of a system on-chip (SoC) design in accordance with embodiments of the disclosure is depicted. As an illustrative example, SoC 1000 is included in user equipment (UE). In one embodiment, UE refers to any device to be used by an end-user to communicate, such as a hand-held phone, smartphone, tablet, ultra-thin notebook, notebook with broadband adapter, or any other similar communication device. A UE may connect to a base station or node, which can correspond in nature to a mobile station (MS) in a GSM network. The embodiments of the page additions and content copying can be implemented in SoC 1000.

Here, SoC 1000 includes 2 cores—1006 and 1007. Similar to the discussion above, cores 1006 and 1007 may conform to an Instruction Set Architecture, such as a processor having the Intel® Architecture Core™, an Advanced Micro Devices, Inc. (AMD) processor, a MIPS-based processor, an ARM-based processor design, or a customer thereof, as well as their licensees or adopters. Cores 1006 and 1007 are coupled to cache control 1008 that is associated with bus interface unit 1009 and L2 cache 1010 to communicate with other parts of system 1000. Interconnect 1011 includes an on-chip interconnect, such as an IOSF, AMBA, or other interconnects discussed above, which can implement one or more aspects of the described disclosure.

Interconnect 1011 provides communication channels to the other components, such as a Subscriber Identity Module (SIM) 1030 to interface with a SIM card, a boot ROM 1035 to hold boot code for execution by cores 1006 and 1007 to initialize and boot SoC 1000, a SDRAM controller 1040 to interface with external memory (e.g. DRAM 1060), a flash controller 1045 to interface with non-volatile memory (e.g. Flash 1065), a peripheral control 1050 (e.g. Serial Peripheral Interface) to interface with peripherals, video codecs 1020 and video interface 1025 to display and receive input (e.g. touch enabled input), GPU 1015 to perform graphics related computations, etc. Any of these interfaces may incorporate aspects of the embodiments described herein.

In addition, the system illustrates peripherals for communication, such as a Bluetooth module 1070, 3G modem 1075, GPS 1080, and Wi-Fi 1085. Note as stated above, a UE includes a radio for communication. As a result, these peripheral communication modules may not all be included. However, in a UE some form of a radio for external communication should be included.

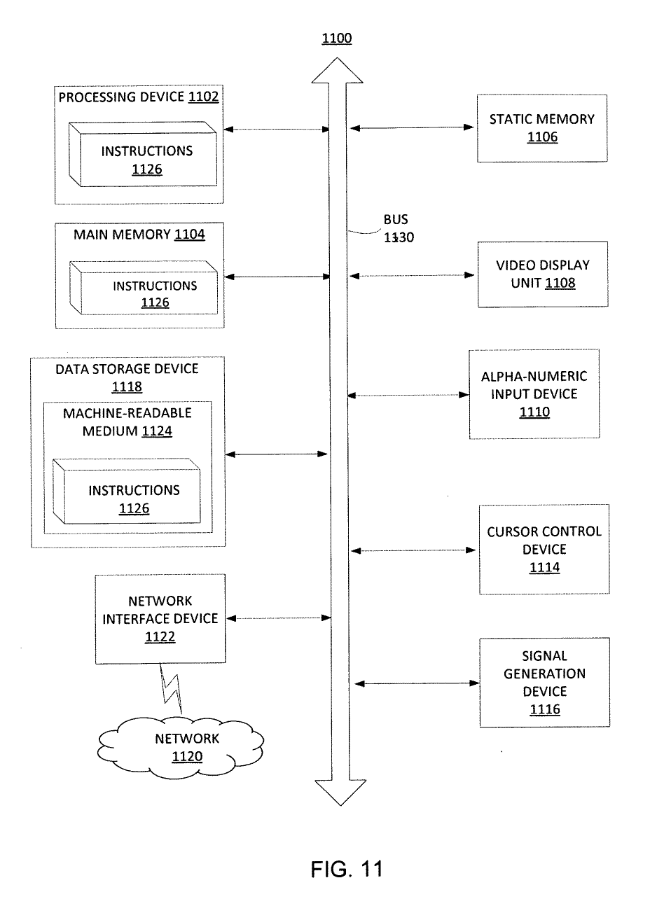

FIG. 11 illustrates a diagrammatic representation of a machine in the example form of a computing system 1100 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. The embodiments of the page additions and content copying can be implemented in computing system 1100.

The computing system 1100 includes a processing device 1102, main memory 1104 (e.g., read-only memory (ROM), flash memory, dynamic random access memory (DRAM) (such as synchronous DRAM (SDRAM) or DRAM (RDRAM), etc.), a static memory 1106 (e.g., flash memory, static random access memory (SRAM), etc.), and a data storage device 1118, which communicate with each other via a bus 1130.

Processing device 1102 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1102 may also be one or more special-purpose processing devices such as an application specific integrated circuit (ASIC), a field programmable gate array (FPGA), a digital signal processor (DSP), network processor, or the like. In one embodiment, processing device 1102 may include one or processor cores. The processing device 1102 is configured to execute the processing logic 1126 for performing the operations discussed herein. In one embodiment, processing device 1102 can be part of a computing system. Alternatively, the computing system 1100 can include other components as described herein. It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

The computing system 1100 may further include a network interface device 1108 communicably coupled to a network 1120. The computing system 1100 also may include a video display unit 1110 (e.g., a liquid crystal display (LCD) or a cathode ray tube (CRT)), an alphanumeric input device 1110 (e.g., a keyboard), a cursor control device 1114 (e.g., a mouse), a signal generation device 1116 (e.g., a speaker), or other peripheral devices. Furthermore, computing system 1100 may include a graphics processing unit 1122, a video processing unit 1128 and an audio processing unit 1132. In another embodiment, the computing system 1100 may include a chipset (not illustrated), which refers to a group of integrated circuits, or chips, that are designed to work with the processing device 1102 and controls communications between the processing device 1102 and external devices. For example, the chipset may be a set of chips on a motherboard that links the processing device 1102 to very high-speed devices, such as main memory 1104 and graphic controllers, as well as linking the processing device 1102 to lower-speed peripheral buses of peripherals, such as USB, PCI or ISA buses.

The data storage device 1118 may include a computer-readable storage medium 1124 on which is stored software 1126 embodying any one or more of the methodologies of functions described herein. The software 1126 may also reside, completely or at least partially, within the main memory 1104 as instructions 1126 and/or within the processing device 1102 as processing logic 1126 during execution thereof by the computing system 1100; the main memory 1104 and the processing device 1102 also constituting computer-readable storage media.

The computer-readable storage medium 1124 may also be used to store instructions 1126 utilizing the processing device 1102, such as described with respect to FIGS. 1A and 1B, and/or a software library containing methods that call the above applications. While the computer-readable storage medium 1124 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instruction for execution by the machine and that cause the machine to perform any one or more of the methodologies of the present embodiments. The term “computer-readable storage medium” shall accordingly be taken to include, but not be limited to, solid-state memories, and optical and magnetic media.

The following examples pertain to further embodiments of the disclosure.

Example 1 is a processor comprising: a first register comprising a plurality of first register positions to receive a plurality of source elements; a second register comprising a plurality of second register positions; and an execution unit coupled to the first register and the second register, the execution unit to: receive a vector of integer values; retrieve a source element having an offset with respect to a base position of the first register; store the source element to a position of the second register, wherein the position is identified by a value of an element of the vector of integer values, the element having the offset with respect to a base position of the vector of integer values.

In Example 2, the subject matter of Example 1, further comprising a plurality of demultiplexers, wherein each of the plurality of first register positions is coupled to one of the plurality of demultiplexers.

In Example 3, the subject matter of Example 1, further comprising a plurality of demultiplexers, wherein each of the plurality of demultiplexers is coupled to each of the plurality of second register positions.

In Example 4, the subject matter of Example 1, further comprising a plurality of demultiplexers, wherein the vector of integers is received at a third register and each of a plurality of third register positions is coupled to one of the plurality of demultiplexers.

In Example 5, the subject matter of Example 4, wherein the element of the vector of integer values indicates a data output line for a coupled demultiplexer.

In Example 6, the subject matter of Example 1, wherein each source element has a corresponding integer in the vector of integer values and wherein the execution unit is to store each source element to a respective position of the second register, wherein the respective position in the second register for each source element is identified by the corresponding integer.

In Example 7, the subject matter of Example 6, wherein to store each element of the plurality of source elements to a respective position of the second register, the execution unit is to store the source elements in parallel.

Example 8, is a processor comprising: a processor core; and a memory device coupled to the processor core, wherein the memory device comprises micro-code to cause the processor core to: receive a plurality of source elements at a first register of the processor; receive a vector of integer values; retrieve a source element having an offset with respect to a base position of the first register; store the source element to a position of a second register, wherein the position is identified by a value of an element of the vector of integer values, the element having the offset with respect to a base position of the vector of integer values.

In Example 9, the subject matter of Example 8, wherein the micro-code further causes processor core to generate a second vector of integer values based on the vector of integer values.

In Example 10, the subject matter of Example 9, wherein to generate a second vector of integer values, the processor core is to store a value equal to the offset with respect to the base position to a second position at a second offset from a second base position of the second vector, wherein the second offset is an integer equal to the value of the element of the vector of integer values

In Example 11, the subject matter of Example 9, wherein to retrieve the source element, the processor core is to identify the source element based on a second element in the second vector of integer values, wherein the offset is equal to the value of the element of the second vector of integer values and the position of the second register is equal to the value of the element of the vector of integer values.

In Example 12, the subject matter of Example 8, wherein the first register is a vector register and wherein the processor cores is to store in parallel each of the source elements to the second register.

In Example 13, the subject matter of Example 7, wherein the memory device comprises a micro-code read only memory.

Example 14 is a method comprising: receiving, by a processor, a plurality of source elements to a first register of the processor, wherein each source element has an offset with respect to a base position of the first register; receiving, by the processor, an index having index elements, wherein each index element has an offset with respect to a base position of the index, and wherein each index element corresponds to a source element having the same offset; storing, by the processor, each of the source elements to positions in a second register of the processor, wherein the positions are identified by values of the corresponding index elements.

In Example 15, the subject matter of Example 14, further comprising generating, by the processor, a second index based on the index.

In Example 16, the subject matter of Example 15, wherein each entry of the second index has a value that identifies a source element, wherein the source element is identified by the offset of the source element.

In Example 17, the subject matter of Example 15, wherein, generating a second index comprises converting in parallel each element of the index to an element of the second.

In Example 18, the subject matter of Example 14, wherein storing each of the source elements to positions in the second register of the processor comprises: providing, by the processor, each source element to a corresponding demultiplexer of a plurality of demultiplexers; providing, to each demultiplexer, an entry in the index; and outputting, from each demultiplexer, the corresponding source element to a data output line indicated by the index.

In Example 19, the subject matter of Example 18, wherein each of the plurality of demultiplexers has a data output line coupled to each position in the second register.

In Example 20, the subject matter of Example 14, wherein storing each of the source elements to the second register is performed in parallel by the processor.

Example 21 is a machine readable medium including code, when executed, to cause a machine to perform the method of any one of Examples 14 to 20.

Example 22 is an apparatus comprising means for performing the method of any one of claims 14 to 20.

Example 23 is an apparatus comprising a processor configured to perform the method of any one of claims 14 to 20.

Example 24 is an apparatus comprising: means for receiving a plurality of source elements to a first register of a processor, wherein each source element has an offset with respect to a base position of the first register; means for receiving an index having index elements, wherein each index element has an offset with respect to a base position of the index, and wherein each index element corresponds to a source element having the same offset; means for storing each of the source elements to positions in a second register of the processor, wherein the positions are identified by values of the corresponding index elements.

In Example 25, the subject matter of Example 24, further comprising: means for generating a second index based on the index, wherein each entry of the second index has a value that identifies a source element, wherein the source element is identified by the offset of the source element.

In Example 26, the subject matter of Example 24, further comprising: means for providing each source element to a corresponding demultiplexer of a plurality of demultiplexers; means for providing an entry from the index to each of the plurality of demultiplexers; and means for storing an output of each demultiplexer to a position in the second register.

Example 27 is a system comprising: a processor core; and a memory device coupled to the processor core, wherein the memory device comprises micro-code to cause the processor core to: receive a plurality of source elements at a first register of the processor; receive a vector of integer values; retrieve a source element having an offset with respect to a base position of the first register; store the source element to a position of a second register, wherein the position is identified by a value of an element of the vector of integer values, the element having the offset with respect to a base position of the vector of integer values.

In Example 28, the subject matter of Example 27, wherein the micro-code further causes the processor core to generate a second vector of integer values based on the vector of integer values.

In Example 29, the subject matter of Example 28, wherein to generate a second vector of integer values, the processor core is to store a value equal to the offset with respect to the base position to a second position at a second offset from a second base position of the second vector, wherein the second offset is an integer equal to the value of the element of the vector of integer values.

In Example 30, the subject matter of Example 28, wherein to retrieve the source element, the processor core is to identify the source element based on a second element in the second vector of integer values, wherein the offset is equal to the value of the element of the second vector of integer values and the position of the second register is equal to the value of the element of the vector of integer values.

While the present invention has been described with respect to a limited number of embodiments, those skilled in the art will appreciate numerous modifications and variations therefrom. It is intended that the appended claims cover all such modifications and variations as fall within the true spirit and scope of this present invention.

In the description herein, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system have not been described in detail in order to avoid unnecessarily obscuring the present invention.

The embodiments are described with reference to performing conjugate permute instructions in specific integrated circuits, such as in computing platforms or microprocessors. The embodiments may also be applicable to other types of integrated circuits and programmable logic devices. For example, the disclosed embodiments are not limited to desktop computer systems or portable computers, such as the Intel® Ultrabooks™ computers. And may be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. It is described that the system can be any kind of computer or embedded system. The disclosed embodiments may especially be used for low-end devices, like wearable devices (e.g., watches), electronic implants, sensory and control infrastructure devices, controllers, supervisory control and data acquisition (SCADA) systems, or the like. Moreover, the apparatuses, methods, and systems described herein are not limited to physical computing devices, but may also relate to software optimizations for energy conservation and efficiency. As will become readily apparent in the description below, the embodiments of methods, apparatuses, and systems described herein (whether in reference to hardware, firmware, software, or a combination thereof) are vital to a ‘green technology’ future balanced with performance considerations.

Although the embodiments herein are described with reference to a processor, other embodiments are applicable to other types of integrated circuits and logic devices. Similar techniques and teachings of embodiments of the present invention can be applied to other types of circuits or semiconductor devices that can benefit from higher pipeline throughput and improved performance. The teachings of embodiments of the present invention are applicable to any processor or machine that performs data manipulations. However, the present invention is not limited to processors or machines that perform 512 bit, 256 bit, 128 bit, 64 bit, 32 bit, or 16 bit data operations and can be applied to any processor and machine in which manipulation or management of data is performed. In addition, the description herein provides examples, and the accompanying drawings show various examples for the purposes of illustration. However, these examples should not be construed in a limiting sense as they are merely intended to provide examples of embodiments of the present invention rather than to provide an exhaustive list of all possible implementations of embodiments of the present invention.

Although the examples herein describe instruction handling and distribution in the context of execution units and logic circuits, other embodiments of the present disclosure can be accomplished by way of a data or instructions stored on a machine-readable, tangible medium, which when performed by a machine cause the machine to perform functions consistent with at least one embodiment of the disclosure. In one embodiment, functions associated with embodiments of the present invention are embodied in machine-executable instructions. The instructions can be used to cause a general-purpose or special-purpose processor that is programmed with the instructions to perform the steps of the present disclosure. Embodiments of the present disclosure may be provided as a computer program product or software which may include a machine or computer-readable medium having stored thereon instructions which may be used to program a computer (or other electronic devices) to perform one or more operations according to embodiments of the present disclosure. Alternatively, operations of embodiments of the present disclosure might be performed by specific hardware components that contain fixed-function logic for performing the operations, or by any combination of programmed computer components and fixed-function hardware components.

Instructions used to program logic to perform embodiments of the disclosure can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present invention.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 0's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1110 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the invention may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer)

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. The blocks described herein can be hardware, software, firmware or a combination thereof.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “defining,” “receiving,” “determining,” “issuing,” “linking,” “associating,” “obtaining,” “authenticating,” “prohibiting,” “executing,” “requesting,” “communicating,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Also, the terms “first,” “second,” “third,” “fourth,” etc. as used herein are meant as labels to distinguish among different elements and may not necessarily have an ordinal meaning according to their numerical designation.

What is claimed is:

1. A processor comprising:
a first register comprising a plurality of first register positions to receive a plurality of source elements;
a second register comprising a plurality of second register positions; and
an execution unit coupled to the first register and the second register, the execution unit to:
receive a vector of integer values;
retrieve a source element having an offset with respect to a base position of the first register;
store the source element to a position of the second register, wherein the position is identified by a value of an element of the vector of integer values, the element having the offset with respect to a base position of the vector of integer values.

2. The processor of claim 1, further comprising a plurality of demultiplexers, wherein each of the plurality of first register positions is coupled to one of the plurality of demultiplexers.

3. The processor of claim 1, further comprising a plurality of demultiplexers, wherein each of the plurality of demultiplexers is coupled to each of the plurality of second register positions.

4. The processor of claim 1, further comprising a plurality of demultiplexers, wherein the vector of integers is received at a third register and each of a plurality of third register positions is coupled to one of the plurality of demultiplexers.

5. The processor of claim 4, wherein the element of the vector of integer values indicates a data output line for a coupled demultiplexer.

6. The processor of claim 1, wherein each source element has a corresponding integer in the vector of integer values and wherein the execution unit is to store each source element to a respective position of the second register, wherein the respective position in the second register for each source element is identified by the corresponding integer.

7. The processor of claim 6, wherein to store each element of the plurality of source elements to a respective position of the second register, the execution unit is to store the source elements in parallel.

8. A processor comprising:
a processor core; and
a memory device coupled to the processor core, wherein the memory device comprises micro-code to cause the processor core to:
receive a plurality of source elements at a first register of the processor;
receive a vector of integer values;
retrieve a source element having an offset with respect to a base position of the first register;
store the source element to a position of a second register, wherein the position is identified by a value of an element of the vector of integer values, the element having the offset with respect to a base position of the vector of integer values.

9. The processor of claim 8, wherein the micro-code further causes processor core to generate a second vector of integer values based on the vector of integer values.

10. The processor of claim 9, wherein to generate a second vector of integer values further, the processor core is to store a value equal to the offset with respect to the base position to a second position at a second offset from a second base position of the second vector, wherein the second offset is an integer equal to the value of the element of the vector of integer values.

11. The processor of claim 9, wherein to retrieve the source element, the processor core is to identify the source element based on a second element in the second vector of integer values, wherein the offset is equal to the value of the element of the second vector of integer values and the position of the second register is equal to the value of the element of the vector of integer values.

12. The processor of claim 8, wherein the first register is a vector register and wherein the processor cores is to store in parallel each of the source elements to the second register.

13. The processor of claim 8, wherein the memory device comprises a micro-code read only memory.

14. A method comprising:
receiving, by a processor, a plurality of source elements to a first register of the processor, wherein each source element has an offset with respect to a base position of the first register;
receiving, by the processor, an index having index elements, wherein each index element has an offset with respect to a base position of the index, and wherein each index element corresponds to a source element having the same offset;
storing, by the processor, each of the source elements to positions in a second register of the processor, wherein the positions are identified by values of the corresponding index elements.

15. The method of claim 14, further comprising generating, by the processor, a second index based on the index.

16. The method of claim 15, wherein each entry of the second index has a value that identifies a source element, wherein the source element is identified by the offset of the source element.

17. The processor of claim 15, wherein, generating a second index comprises converting in parallel each element of the index to an element of the second index.

18. The method of claim 14, wherein storing each of the source elements to positions in the second register of the processor comprises:
providing, by the processor, each source element to a corresponding demultiplexer of a plurality of demultiplexers;
providing, to each demultiplexer, an entry in the index; and
outputting, from each demultiplexer, the corresponding source element to a data output line indicated by the index.

19. The method of claim 18, wherein each of the plurality of demultiplexers has a data output line coupled to each position in the second register.

20. The method of claim 14, wherein storing each of the source elements to the second register is performed in parallel by the processor.
